(19) United States
(12) Patent Application Publication
(10) Pub. No.: US 2026/0244676 A1
(43) Pub. Date: Aug. 20, 2026

(54) VECTOR DATABASE-BASED TIME EFFICIENT PROCESS FOR ENTRY INCLUSION

(71) Applicant: Dell Products L.P., Round Rock, TX (US)

(72) Inventors: Ibrahim Abu Alhaol, Nepean (CA); Mustafa Al-Bado, Cork (IE); Said Tabet, Austin, TX (US); Gwenael Poitau, Montreal (CA)

(21) Appl. No.: 19/056,052

(22) Filed: Feb. 18, 2025

(51) Int. Cl. G06F 16/36; G06F 16/383

(52) U.S. Cl. CPC G06F 16/367; G06F 16/383

(57) ABSTRACT

Creating new relationships and entries in an ontology is disclosed. When a new entry is received, a similarity analysis is performed to determine how similar the new entry is to existing entries in the ontology. When the new entry is sufficiently similar, the ontology may be updated with the new entry. If the new entry is sufficiently dissimilar, a validation analysis is performed to determine whether the new entry is valid. If valid, the new entry is added to the ontology and if invalid, the new entry is rejected for further analysis.

### TECHNOLOGICAL FIELD OF THE DISCLOSURE

Embodiments disclosed herein generally relate to structures that store data and to managing the structures. More particularly, at least some embodiments relate to systems, hardware, software, computer-readable media, and methods for managing an ontology, which includes adding entries to the ontology.

### BACKGROUND

A variety of tools exist for using and managing data. Large language models (LLMs) are examples of artificial intelligence systems that are capable of interpreting and producing text that closely resembles natural human language. LLMs have broad applicability in various fields and are particularly useful in applications that depend on language analysis and language generation.

LLMs may use various data sources for generating responses to a query. Examples of the sources may include graphs of various types including knowledge graphs and ontologies. A knowledge graph, for example, is a graphical representation of knowledge and may illustrate how different concepts, entities, and events interconnect. Knowledge graphs allow large amount of data to be navigated and provide insights into how various pieces of data are interrelated. Knowledge graphs are often used in applications such as semantic web services, data integration, and artificial intelligence.

Another example of a data source is an ontology. While an ontology has various similarities to a knowledge graph, an ontology is a formal representation of knowledge as a set of concepts withing a domain and the relationships between those concepts.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1A discloses aspects of an ontology management engine configured to manage and/or control an ontology;

FIG. 1B discloses aspects of extracting text, including ontology triples, from an input source;

FIG. 1C discloses aspects of extracting text from an input source;

FIG. 2 discloses aspects of the ontology management engine and aspects of adding entries to an ontology;

FIGS. 3A-3C discloses aspects of a method for evaluating a new entry for inclusion in an ontology;

FIG. 4 discloses aspects evaluating an entry for inclusion in an ontology; and

FIG. 5 discloses aspects of a computing device, a computing system, or a computing entity.

### DETAILED DESCRIPTION OF SOME EXAMPLE EMBODIMENTS

Embodiments disclosed herein generally relate to ontology management. More particularly, at least some embodiments relate to systems, hardware, software, computer-readable media, and methods for changing and/or revising ontologies, which includes adding entries (e.g., subject nodes, relations, and/or object nodes) to ontologies.

Embodiments of the invention relate to ontologies and are discussed in the context of web ontology language (OWL) and resource description framework (RDF). Embodiments of the invention are further discussed in the context of ontologies that are constructed using triples. Embodiments of the invention, however, are not limited to these languages, frameworks, and methods of construction. Other frameworks may include relational models, taxonomic hierarchies, or the like. The type of ontology selected for a given purpose may depend on the domain of the ontology. In addition, embodiments of the invention may be adapted to managing other structures such as linked structures, knowledge graphs, network graphs, and the like.

Generally, an ontology may be represented as a graph using nodes and edges. The nodes of an ontology may represent, by way of example only and not limitation, classes and instances. Classes may represent the categories of a domain while instances may be specific examples of a class. Relations or relationships (e.g., edges) may define how classes, instances, and the like are related to each other. Classes and instances may be associated with attributes, which may relate to properties or characteristics of a class or instance. An ontology may also be associated with rules that may determine or define how classes and relationships interact.

An ontology is often constructed using building blocks such as triples. OWL and RDF are examples of web technologies that employ triples. A triple (e.g., subject, predicate, and object) is used to define or describe knowledge in an ontology. By way of example, the subject may be the class being described, the object may be the value or instance associated with the subject via the predicate, which describes the relationship of the subject to the object.

RDF is an example of a formal structure that may be used within a domain of knowledge. RDF is often used as a framework to represent data on the web.

For example, a triple may be expressed in natural language as follows:

Arizona (subject) includes a city of (predicate) in Phoenix (object).

In RDF, this triple may be expressed as follows:

http://example.org/Arizona, http://example.org/includesCityOf, http://example.org/Phoenix.

In this example, each part of the triple is identified by a URL (Uniform Resource Locator). Triples may be used, by way of example only, to describe class hierarchies (e.g., city is a subclass of State), attributes (e.g., city has a population of number), and relationships between entities (e.g., cities require water).

A web ontology language (OWL) ontology is another example that may be used to represent, define, and/or store knowledge within a specific domain.

Embodiments of the invention relate to creating a new entry (e.g., a node and/or relationship) in an ontology. Creating a new entry in an ontology conventionally consumes significant resources, particularly when there is duplication.

For example, duplication may exist when two triples represent the same concept, but are phrased differently. Adding duplicate entries to an ontology makes the ontology redundant. Failing to remove the redundancies from an ontology or failing to prevent the inclusion of a redundant entry may result in inefficiencies and inaccuracies. Embodiments of the invention relate to ontology management, which includes adding entries to an ontology, removing/preventing redundancies in the ontology, or the like.

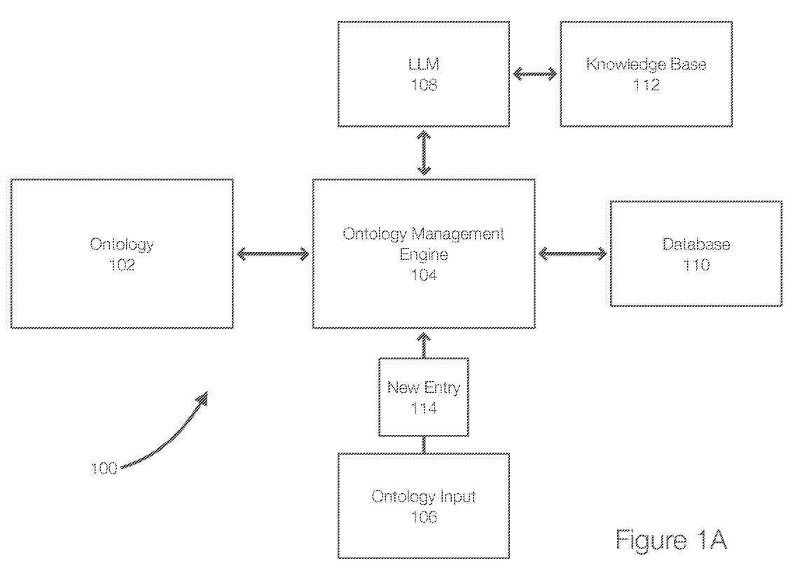

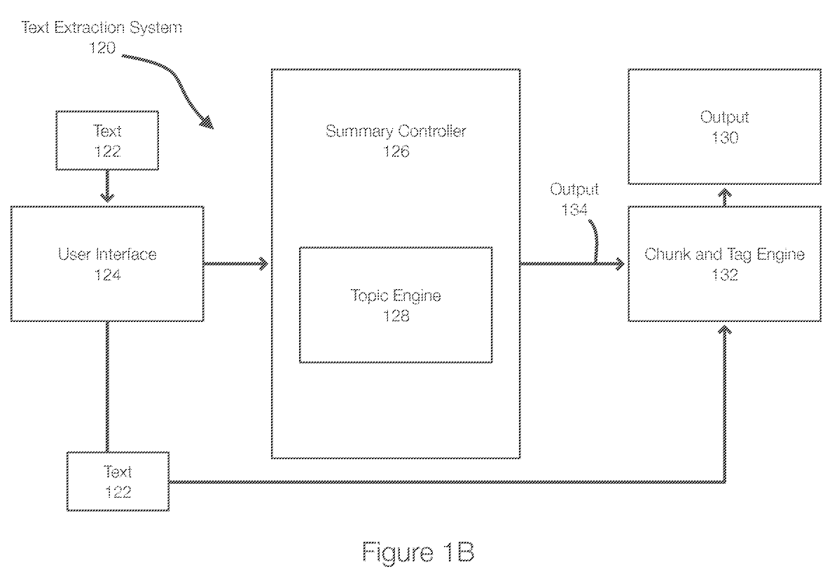

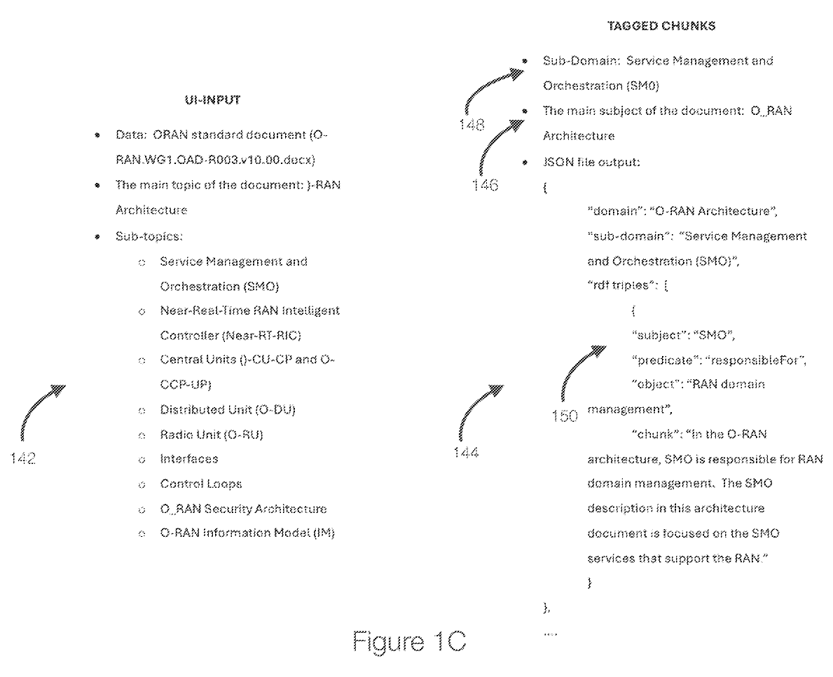

FIG. 1A discloses aspects of an ontology management engine configured to manage and/or control an ontology. FIG. 1 illustrates an ontology 102, which may be stored in a storage system or a storage device (e.g., on-premise storage, cloud storage). The ontology 102 is managed by an ontology management engine 104 (engine 104). The engine 104 may be implemented in a server, a system or servers, or other computing systems. The engine 104 may be edge-based, cloud-based, distributed, or the like and/or may be accessed over a network (e.g., via a Uniform Resource Locator). The system 100, by way of example, may be an edge-based system, a cloud-based system, an on-premise system, or a distributed system or combinations thereof.

In this example, ontology input 106 (input 106) may be received from a user (e.g., an ontology domain expert) at the engine 104. The input 106 may include a new entry 114 and an instruction to add the entry 114 to the ontology 102. In this example, the engine 104 determines whether to add the entry 114 to the ontology 102 by performing a similarity analysis and/or a validation analysis. In one example, the ontology input 106 may be extracted text.

FIG. 1B discloses aspects of extracting text, including ontology triples, from an input source and FIG. 1C discloses additional aspects of extracting text from an input source. More specifically, FIG. 1B discloses aspects of extracting text from a source. FIG. 1B illustrates an example of text extraction system 120 (system 120). In one example, text 122 (e.g., a document or other source or portion thereof) is input to the system 122 via a user interface 124. The text 122 is provided to a summary controller 126 that includes a topic engine 128. The topic engine 128 may include a large language model (LLM) configured to identify and summarize main topics and sub-topics included in the text 122. Thus, the response or output 134 of the topic engine 128 (or summary controller 126) may include main topics and sub-topics of the text 122.

The text 122 and the output 134 of the topic engine 128 are provided to the chunk and tag engine 132 (engine 132). The engine 132 may include an LLM configured to craft triples (subject, predicate, object) from the text 122 based on context, which may include the main topics and sub-topics of a domain identified by the topic engine 128 and included in the output 134 and the text 122. The output 130 of the engine 132 may include tagged chunks or tagged text. The output 130 may be a source of triples (a set of triples) that may be evaluated for inclusion in an ontology.

FIG. 1C discloses aspects of generating tagged chunks from user input. FIG. 1B illustrates text 142, which is an example of the text 122, that may be input to the system 120 via the user interface 124 to the summary controller 126. The topic engine 128 may receive the text 142. The text 142 may be used to prompt an LLM and the response of the LLM may include a main topic or domain (e.g., main domain 146) and/or sub-topics or sub-domains (e.g., sub-domain 148).

The engine 128 is configured to generate a triple 150 (or multiple triples) from the text 142 and the context. The context may include the domain 146 and/or sub-domain 148 generated by the summary controller 126 and/or the text 142. In this example, the extracted text 144 is an example of the output 130 of the system 120. The extracted text 144 or portions thereof may be stored in a node database. Returning to FIG. 1A, the engine 104 performs a similarity analysis and a validation analysis on the new entry 14, which may be a triple from extracted text. The engine 104 may perform the similarity analysis using a database 110. The engine 104 may perform a validation analysis with a large language model (LLM) 108.

For example, the engine 104 may have access to the database 110. In one example, the database 110 is a vector database that stores embeddings of entries in the ontology 102 (or in a node database). When the new entry 114 is received by the engine 104, the engine 104 may embed the new entry 114 to generate a new entry embedding and compare the new entry embedding to embeddings in the database 110.

The similarity analysis of comparing the new entry embedding with the embeddings in the database 110 may determine subsequent operations. In one example, when the similarity analysis suggests that the new entry is highly similar to an entry in the ontology 102, the operation of determining whether to add the new entry 114 to the ontology 102 may fail or stop. However, the process may proceed if desired.

After the similarity analysis, the engine 104 may perform a validation analysis. More specifically, the engine 104 may have access to a large language model (LLM) 108 that is configured or trained with respect to the domain of the ontology 102. The LLM 108 may have access to a knowledge base of documents, data, or other information related to the domain.

In one example, if the new entry embedding is sufficiently dissimilar from existing embeddings in the database 110, the engine 104 may validate the new entry 114 with the LLM 108. The LLM 108 may be able to determine whether the new entry 114 is valid, true, or the like. Once the new entry 114 is validated, the new entry 114 may be added to the ontology 102 by the engine 104.

For example, an entity that sells computing hardware, software, cloud-services, or the like may build or construct an ontology 102 whose domain is computing systems and services. The LLM 108 may include or have access to a knowledge base 112 (and/or other sources) that stores computing standards, product documentation, white papers, or the like. This allows the LLM 108 to generate responses based on documents or other data relevant to the domain of the ontology 102.

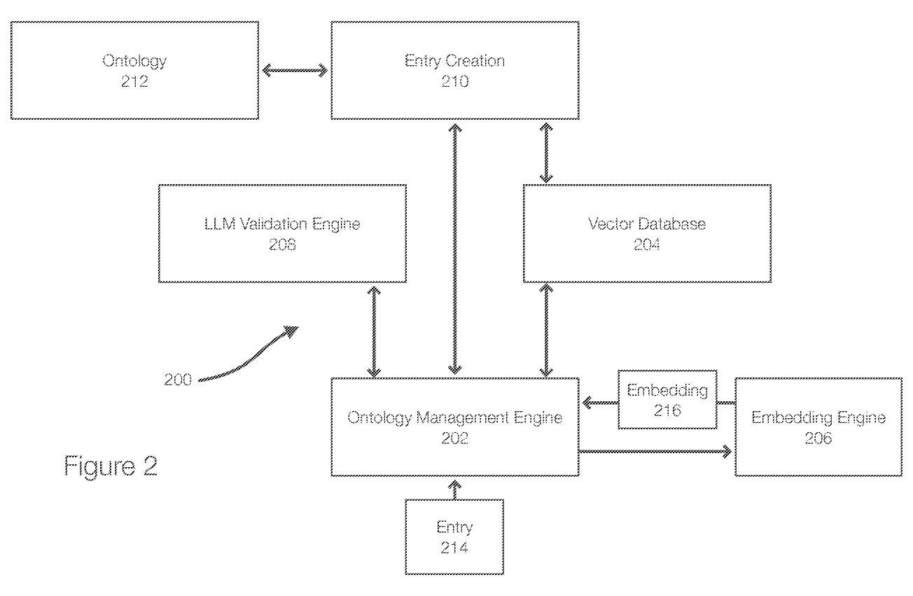

FIG. 2 discloses additional aspects of a system configured for managing ontologies. FIG. 2 illustrates a system 200, which is an example of the system 100, that includes an ontology management engine 202. The ontology 212 is associated with a domain in one example and includes entries. The ontology 212 may be represented using nodes and edges by way of example. The nodes may represent classes, subclasses, instances, and the like. The edges may represent relationships or properties between the connected nodes. Embodiments of the invention are not limited to this representation of an ontology.

In one example, embeddings (vector representations) for entries (e.g., nodes, relationships) in the ontology 212 may be generated by an embedding engine 206 and stored in the vector database 204. Thus, the vector database 204 stores a representation of the ontology 212 in vector form.

When performing a management operation such as adding an entry to the ontology, a proposed new entry 214 is received by the engine 202. The engine 202 may send the entry 214 to an embedding engine 206 and the embedding engine 206 returns a new entry embedding 216.

The embedding 216 is compared with embeddings in the vector database 204. More specifically in one example, embeddings are high dimensional numerical representations of the entries in the ontology 212. As a result, the embedding 216 can be compared to the embeddings in the vector database 204 using comparison mechanisms such as cosine similarity, Euclidean distance, or the like.

In one example, a similarity threshold may be determined by an expert, based on historical comparisons, by default, or the like. The similarity threshold, for example, may be set at .9 (e.g., on a scale from 0 to 1). This may allow the entry 214 to be classified as similar or dissimilar based on the similarity threshold alone.

When the engine 202 determines that the entry 214 is similar (e.g., similarity score higher than a threshold similarity score), the entry 214, rather than being added to the ontology 212 as a new entry, is used to augment existing entries in the ontology. The entries to be augmented include entries that are sufficiently similar (based on similarity scores). More specifically, in one example, the most similar entry is augmented.

When the similarity score is below the similarity threshold, the entry 214 may be validated by the LLM validation engine 208 (engine 208). In this example, the entry 214, rather than the embedding 216, is input to the engine 208 and expressed in natural language in one example. However, the embedding 216 could also be input to the LLM validation engine 208. The engine 208 may be prompted to determine whether the entry 214 is valid. Validation may include determining whether the entry 214 aligns, agrees, and/or comports with facts or patterns in the sources or training data. More specifically, validation may determine whether the entry 214 is consistent with the ontology 202. The engine 208 may also generate a validation score or probability. For example, an entry related to a Wi-Fi environment may be dissimilar to entry of an ontology related to cellular networks. In this case, the entry fails validation because it is not consistent with cellular networks.

If the new entry 214 is determined to be valid (e.g., the validation score is greater than a threshold validation score), the new entry 214 may be incorporated into the ontology 212. The validation threshold score may be determined empirically, based on validation scores of existing entries, set by a user, or the like.

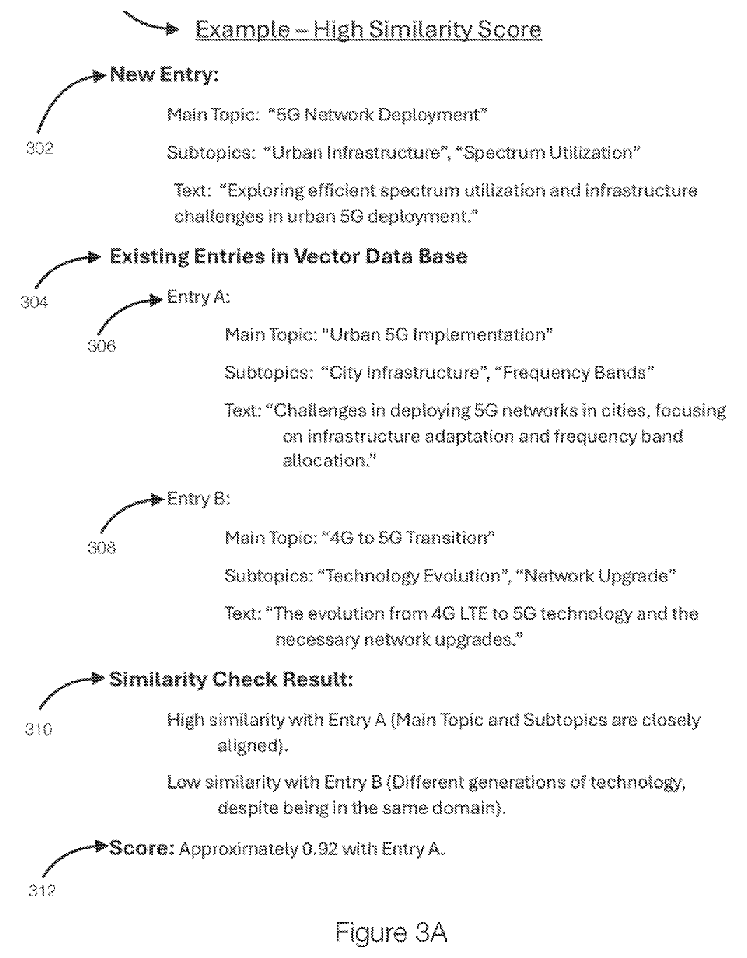

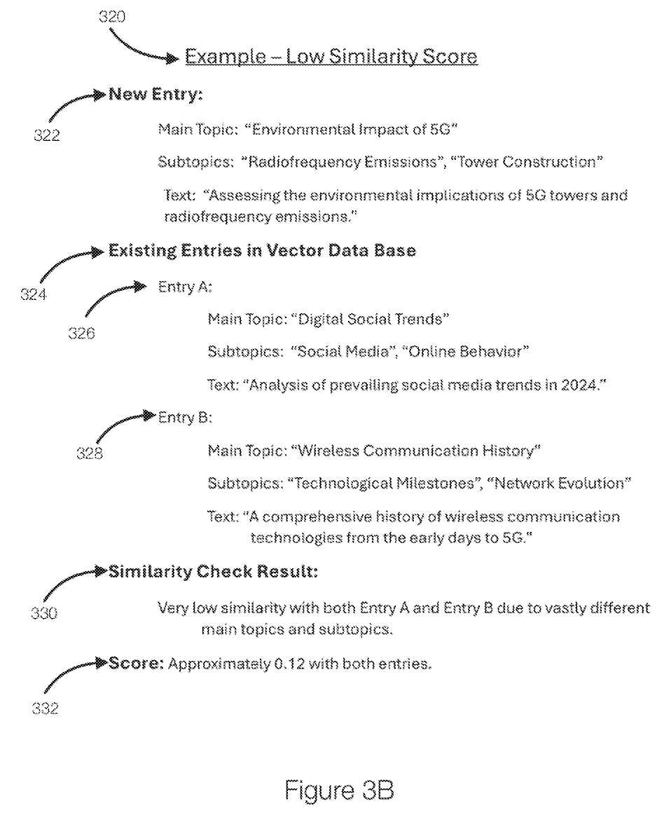

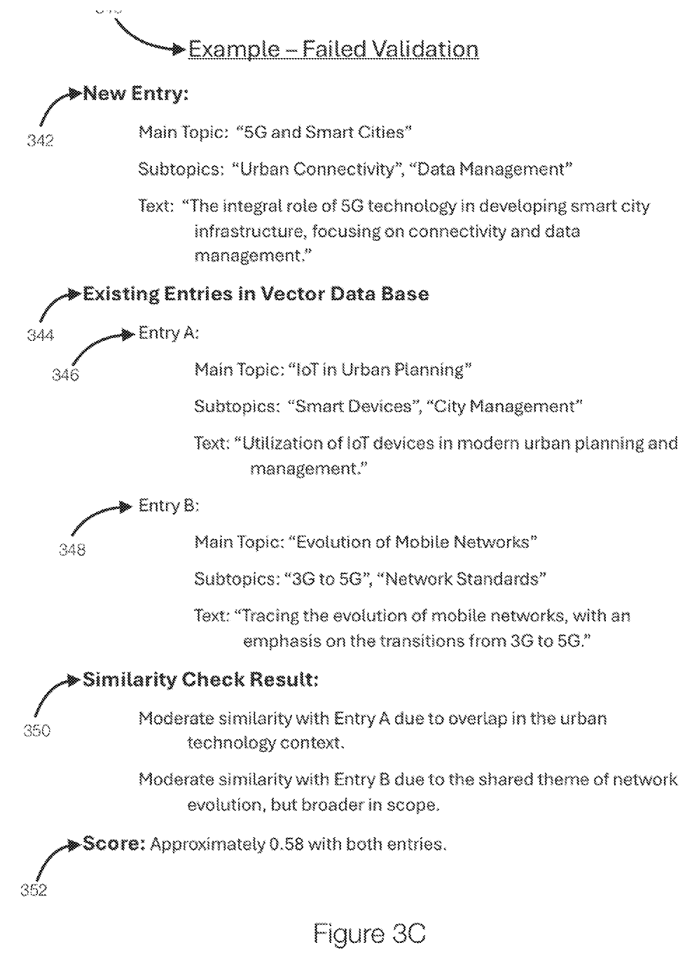

FIG. 3A discloses aspects of an example new entry being evaluated for inclusion in an ontology. In the example 300, a new entry 302 (e.g., extracted text) is received by an ontology management engine. The new entry includes a main topic, subtopics, and text. The vector database 304 includes embeddings of existing entry 306 (entry A) and entry 308 (entry B).

The new entry 302 is embedded by generating an embedding. In one example, the new entry 302 may be chunked and each chunk may be embedded. This may enable, for example, main topic embeddings to be compared with other main topic embeddings. In this example, the comparison of the embedding(s) generated from the new entry 302 and illustrated in the similarity check result 310 suggest that the new entry 302 has high similarity with the entry 306 and low similarity with the entry 308. The similarity score of the new entry 302 is 0.92 with the entry 306.

More specifically, the main topics and subtopics of the new entry 302 and the entry 306 are closely aligned. In contrast, the similarity of the main topics and subtopics of the new entry 302 and the entry 308 is low at least because, as illustrated, the main topics of the new entry 302 and the entry 308 relate to different technologies, even if in the same domain.

In this example 300, assuming that a similarity threshold of .9 is set, the entry 306 is too similar. This suggests that the entry 302 is redundant or duplicative. As such, the new entry 302 may be used to augment existing entries in the ontology.

FIG. 3B discloses aspects of another example entry being evaluated for inclusion in an ontology. In the example 320, a new entry 322 is received by an ontology management engine. The new entry 322 includes a main topic, subtopics, and text. The vector database includes embeddings of the entry 326 and the entry 328.

Thus, an embedding of the new entry 322 is generated and compared to embeddings of the entries 326 and 328. In this example, the similarity check 330 suggests low similarity and yields a score 322 of about 0.12 with respect to each of the entries 326 and 328. The low similarity score is evident at least because the main topic and subtopics are quite distinct from the main topic and subtopics of the new entry 322.

In this example, the new entry 322 is sufficiently dissimilar to the existing entries 324 in the vector database. Thus, the new entry 322 is validated and if the validation is successful, the entry 322 is added to the ontology.

FIG. 3C discloses aspects of a failed validation. The example 340 is an example of a failed validation. In this example, an embedding of the new entry 342 is compared to embeddings of the entry 346 (Entry A) and the entry 348 (Entry B) in the vector database 344. The similarity check result 350 suggests that the entries 346 and 348 have moderate similarity to the new entry 342. The score 352 of 0.58 with respect to both of the entries 346 and 348 indicates that the score of the new entry 342 does not satisfy the similarity threshold score.

Next, the entry 342 is input to an LLM validation engine for validation. If the new entry 342 is validated by the LLM validation engine, the new entry 342 may be subject to further review due to the score 352 due to the ambiguous similarity score. In one example, a range of similarity scores may be used as a trigger for further analysis. This helps prevent duplicate entries in the ontology.

If the validation fails, the new entry 342 is rejected and not added to the ontology or further evaluation is triggered, such as a manual review.

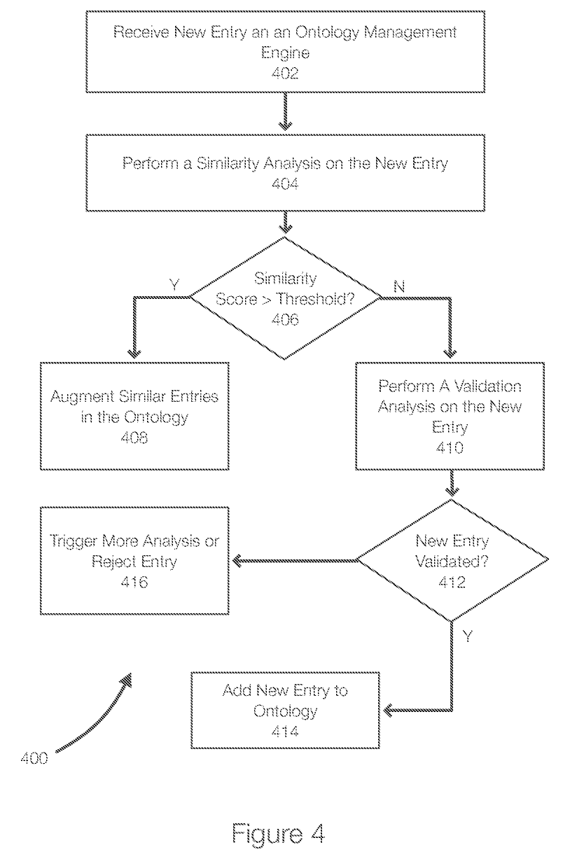

FIG. 4 discloses aspects of a method for evaluating an entry for inclusion in an ontology. The method includes receiving 402 a new entry at an ontology management engine. Once the new entry is received, a similarity analysis is performed 404 on the new entry. The similarity analysis may include embedding the new entry and comparing the new embedding with existing embeddings of entries in the ontology. This may generate a similarity score for the new entry with respect to one or more existing entries.

If the similarity score of the new entry is greater than a similarity threshold score (Y at 406) the most similar entry (or most similar) entries may be augmented 408 with the new entry. In one example, validation may also be performed even if the similarity score is greater than the similarity threshold. This may include supplementing the most similar entry in the ontology with additional tags and contexts in both the ontology and the vector database.

If the similarity score is less than the similarity score threshold (N at 406), a validation analysis is performed 410 on the new entry. The validation analysis may include submitting the new entry to an LLM to determine whether the new entry is valid and acceptable for inclusion in the ontology. If the new entry is successfully validated (Y and 412), the new entry is added 414 to the ontology. If the new entry fails validation, the new entry is rejected 416 or additional analysis is triggered. This may help ensure that valid entries are included in the ontology and that duplicate entries in the ontology are avoided.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, ontology management operations, adding entries to ontologies, similarity operations, validation operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data protection functionality for one or more clients. Another example of a cloud computing environment is one in which processing, data storage, data protection, and other services may be performed on behalf of one or more clients. Some example cloud computing environments in which embodiments may be employed include Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients capable of collecting, modifying, and creating, data. As such, a particular client or server or other computing system may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ or ‘object’ is intended to be broad in scope. Example embodiments are applicable to any system capable of storing and handling various types of objects, in analog, digital, or other form. Further, the AFMs, GNNs, LLMs, and other models may be trained with historical and/or synthetic data.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method comprising: receiving a new entry at an ontology management engine configured to manage an ontology, performing a similarity analysis to determine a similarity score for the new entry with respect to entries in the ontology, performing a validation analysis on the new entry to determine a validation score when the similarity score is below a threshold similarity score, and adding the new entry to the ontology when the similarity score is below a threshold similarity score and the validation score is above a threshold validation score .

Embodiment 2. The method of embodiment 1, wherein the similarity analysis includes generating a new embedding of the new entry.

Embodiment 3. The method of embodiment 1 and/or 2, further comprising comparing the new embedding with embeddings of the entries that are stored in a vector database.

Embodiment 4. The method of embodiment 1, 2, and/or 3, further comprising, when the similarity score is greater than the threshold similarity score, augmenting at least a most similar entry in the ontology to the new entry and augmenting a most similar embedding in the vector database.

Embodiment 5. The method of embodiment 1, 2, 3, and/or 4, further comprising supplementing the most similar entry and/or the most similar embedding with additional tags and contexts from the new entry.

Embodiment 6. The method of embodiment 1, 2, 3, 4, and/or 5, wherein the validation analysis includes submitting the new entry and/or the new embedding to a large language model.

Embodiment 7. The method of embodiment 1, 2, 3, 4, 5, and/or 6, wherein the large language model is configured to determine whether the new entry is aligned with a domain of the ontology and is accurate.

Embodiment 8. The method of embodiment 1, 2, 3, 4, 5, 6, and/or 7, wherein the new entry is aligned when the new entry comports with facts or patterns learned by the large language model.

Embodiment 9. The method of embodiment 1, 2, 3, 4, 5, 6, 7, and/or 8, wherein the large language model is trained on or has access to source documents associated with the domain.

Embodiment 10. The method of embodiment 1, 2, 3, 4, 5, 6, 7, 8, and/or 9, wherein, when the validation analysis fails, the new entry is rejected and not included in the ontology or additional analysis is triggered.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

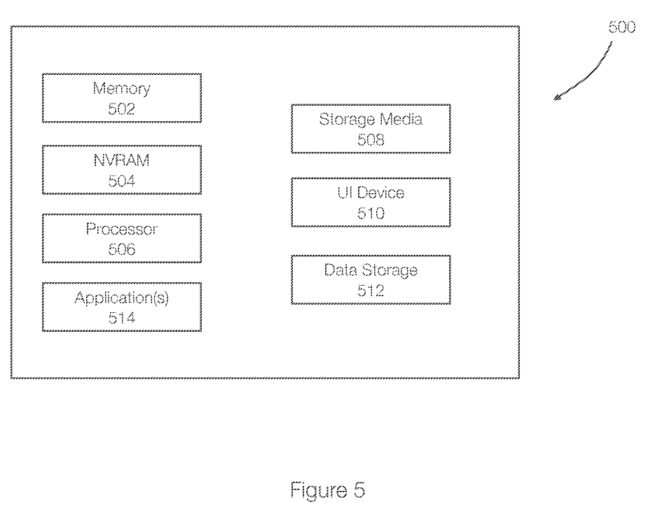

With reference briefly now to FIG. 5, any one or more of the entities disclosed, or implied, by the Figures and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

The device 500 may also represent a computing system such as a server or set of servers, an edge based computing system, a cloud-based computing system, or the like. The computing system may be localized or distributed in nature.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 500 may also represent a physical or virtual machine or server, an edge-based computing system, a cloud-based computing system, server clusters or other computing systems or environments. The device 500 may also represent multiple machines or devices, whether virtual, containerized, or physical. The device 500 may perform or execute steps or acts of the methods illustrated in the Figures.

The device 500 may represent a cloud-based system, an edge-based, system, an on-premise system, or combinations thereof. The device 500 may be a computing system that is distributed geographically.

The described embodiments are to be considered in all respects only as illustrative and not restrictive. All changes which come within the meaning and range of equivalency of the claims are to be embraced within their scope.

What is claimed is:

1. A method for performing ontology management, the method comprising:
receiving a new entry at an ontology management engine configured to manage an ontology;
performing a similarity analysis to determine a similarity score for the new entry with respect to entries in the ontology;
performing a validation analysis on the new entry to determine a validation score when the similarity score is below a threshold similarity score; and
adding the new entry to the ontology when the similarity score is below a threshold similarity score and the validation score is above a threshold validation score .

2. The method of claim 1, wherein the similarity analysis includes generating a new embedding of the new entry.

3. The method of claim 2, further comprising comparing the new embedding with embeddings of the entries that are stored in a vector database.

4. The method of claim 3, further comprising, when the similarity score is greater than the threshold similarity score, augmenting at least a most similar entry in the ontology to the new entry and augmenting a most similar embedding in the vector database.

5. The method of claim 4, further comprising supplementing the most similar entry and/or the most similar embedding with additional tags and contexts from the new entry.

6. The method of claim 1, wherein the validation analysis includes submitting the new entry and/or the new embedding to a large language model.

7. The method of claim 6, wherein the large language model is configured to determine whether the new entry is aligned with a domain of the ontology and is accurate.

8. The method of claim 7, wherein the new entry is aligned when the new entry comports with facts or patterns learned by the large language model.

9. The method of claim 8, wherein the large language model is trained on or has access to source documents associated with the domain.

10. The method of claim 1, wherein, when the validation analysis fails, the new entry is rejected and not included in the ontology or additional analysis is triggered.

11. A non-transitory storage medium having stored therein instructions that are executable by one or more hardware processors to perform operations comprising:
receiving a new entry at an ontology management engine configured to manage an ontology;
performing a similarity analysis to determine a similarity score for the new entry with respect to entries in the ontology;
performing a validation analysis on the new entry to determine a validation score when the similarity score is below a threshold similarity score;
and adding the new entry to the ontology when the similarity score is below a threshold similarity score and the validation score is above a threshold validation score.

12. The non-transitory storage medium of claim 11, wherein the similarity analysis includes generating a new embedding of the new entry.

13. The non-transitory storage medium of claim 12, further comprising comparing the new embedding with embeddings of the entries that are stored in a vector database.

14. The non-transitory storage medium of claim 13, further comprising, when the similarity score is greater than the threshold similarity score, augmenting at least a most similar entry in the ontology to the new entry and augmenting a most similar embedding in the vector database.

15. The non-transitory storage medium of claim 14, further comprising supplementing the most similar entry and/or the most similar embedding with additional tags and contexts from the new entry.

16. The non-transitory storage medium of claim 11, wherein the validation analysis includes submitting the new entry and/or the new embedding to a large language model.

17. The non-transitory storage medium of claim 16, wherein the large language model is configured to determine whether the new entry is aligned with a domain of the ontology and is accurate.

18. The non-transitory storage medium of claim 17, wherein the new entry is aligned when the new entry comports with facts or patterns learned by the large language model.

19. The non-transitory storage medium of claim 18, wherein the large language model is trained on or has access to source documents associated with the domain.

20. The non-transitory storage medium of claim 11, wherein, when the validation analysis fails, the new entry is rejected and not included in the ontology or additional analysis is triggered.
